(19) United States
(12) Patent Application Publication
(10) Pub. No.: US 2026/0024511 A1
(43) Pub. Date: Jan. 22, 2026

(54) IDIOPHONE INSTRUMENTS AND METHODS FOR MAKING AND USING IDIOPHONE INSTRUMENTS

(71) Applicant: Donald E. Michael, Livonia, MI (US)

(72) Inventor: Donald E. Michael, Livonia, MI (US)

(21) Appl. No.: 19/250,689

(22) Filed: Jun. 26, 2025

Related U.S. Application Data
(60) Provisional application No. 63/672,460, filed on Jul. 17, 2024.

(51) Int. Cl. G10D 13/08

(52) U.S. Cl. CPC G10D 13/08

(57) ABSTRACT

Presented are idiophone-type musical instruments, methods for manufacturing such instruments, and methods of using such instruments. An idiophone instrument includes a main body with a main body wall, and multiple elongated fins that are rigidly secured to and project outward from the main body wall. The elongated fins are substantially mutually parallel with one another and spaced in face-to-face relationship with one another. The main body and elongated fins may be integrally formed as a single-piece structure from a metallic material. The elongated fins may project substantially orthogonally from the main body wall. The main body may consist essentially of the main body wall, which may be a substantially flat plate. Each of the elongated fins may have a respective length that is distinct from the lengths of all other fins.

### CLAIM OF PRIORITY AND CROSS-REFERENCE TO RELATED APPLICATION

This application claims the benefit of and priority to U.S. Provisional Patent Application No. 63/672,460, which was filed on Jul. 17, 2024, and is incorporated herein by reference in its entirety and for all purposes.

### INTRODUCTION

The present disclosure relates generally to musical instruments. More specifically, aspects of this disclosure relate to idiophone-type instruments and methods for making and methods for using idiophone instruments.

Musical instruments may be divided into three primary categories: string instruments, percussion instruments, and wind instruments. As the name implies, string instruments—also known as “chordophones”—are essentially musical instruments that produce sound from vibrating strings, such as by plucking a guitar or harp string or by rubbing a violin or cello string with a bow. Pianos and harpsichords are a subclass of chordophones that produce music by pressing a key that activates a hammer or plectrum to strike or pluck a string. Comparatively, wind instruments—also known as “aerophones”—may be typified as musical instruments that produce sound by the vibration of air, typically by blowing air into or across the instrument. Woodwind instruments, for example, are acrophones that produce sound by blowing air across a reed or fipple whereas brass instruments produce sound by vibrating the musician's lips against a mouthpiece.

Percussion instruments, in contrast, are instruments that produce sound when stuck, scraped, rubbed or shaken. One class of percussion instruments is the membranophone that makes sound by striking a membrane stretched across the instrument body. Drums, bongos, and tambourines are all membranophones with a thin, flexible batter head that is stretched across an open end of a toroidal shell. Another type of percussion instrument is the plucked-type idiophone—also known as a “lamellophone”—that makes sound by plucking thin vibrating tangs (or “lamella”) that are cantilevered at one end thereof to a hollow wood or metal box. The lamella are individual tines that are juxtaposed side-by-side with one another and removably fixed to a hollow box via a mounting bracket.

### SUMMARY

Presented below are idiophone-type musical instruments, methods for manufacturing idiophone musical instruments, and methods of using idiophone musical instruments. By way of example, and not limitation, a hand-held idiophone instrument is fabricated with a rigid main body and multiple elongated fins that are rigidly secured to the main body. The main body may be a substantially flat “plate-like” polyhedral structure with a trapezoidal profile. The elongated fins may all project substantially orthogonally outward from one major face of the main body, arranged substantially mutually parallel with one another and spaced in face-to-face relationship with one another. Put another way, the elongated fins may be non-coplanar and arranged in a columnar “ladder-like” pattern. The instrument may contain at least 5-35 vibrating fins that are arranged in a single column or in multiple mutually parallel columns. For a single-row design, every fin may have a rectangular shape with each fin having a distinct size. For a dual-row design, one column of fins all have a rectangular shape with each fin having a distinct size, and the other column of fins may all have a right-trapezoid shape with each fin having a distinct size.

Unlike traditional lamellophones and xylophones, disclosed idiophone instruments may be fabricated such that the instrument body and fins are integrally formed as a one-piece, unitary structure from a metal or metal-alloy material (e.g., rubber grip, paper label, plastic jacket, paint, coating, etc., do not materially affect novel characteristics of design). As another possible non-limiting point of demarcation, the instrument body may be rigid sans an internal cavity. Moreover, the instrument body may lack a sound hole and a mounting (Z) bracket for fixing the fins to the body. As an idiophone, the instrument may also lack vibrating strings, a mouthpiece, a slide, valves, tubing, electrical and electronic componentry, flexible membranes, plectrums, mallets, reeds, and/or fipples. It may also be desirable that a lateral edge of each fin be fixed along the entire longitudinal length thereof to the instrument's main body such that the fins are perpendicular to the body. For at least some designs, the idiophone instrument may consist essentially of the main body, the fins, and, optionally, a handle. For handheld constructions, the idiophone instrument may weigh less than about 2-5 pounds (lbs) (e.g., about 1-2 kilograms) or, for some designs, less than one (1) pound. Additionally, the idiophone may be less than about 12-18 inches (in.) wide, less than about 8-10 in. tall, and/or less than about 2-3 in. deep.

Aspects of this disclosure are directed to idiophone instruments. In an example, an idiophone instrument includes a main body with a main body surface. A plurality of elongated fins is rigidly secured to the main body surface with each fin projecting outward from the main body surface. The elongated fins may be substantially mutually parallel with one another and spaced in face-to-face relationship with one another.

Aspects of this disclosure are also directed to methods of making and methods for using idiophone instruments. In an example, a method of manufacturing an idiophone instrument may include, in any order and in any combination with any of the above and below disclosed options and features: forming a main body including a main body surface; and rigidly securing a plurality of elongated fins to the main body such that the elongated fins project outward from the main body surface, the elongated fins being substantially mutually parallel with one another and spaced in face-to-face relationship with one another. It is envisioned that the idiophone's main body and elongated fins may be formed by extrusion and precision cutting processes and, thus, may lack the use of fasteners, adhesives, brackets, etc.

Additional aspects of this disclosure are directed to hand-held, pluck-type idiophone instruments. In this example the idiophone instrument may consist essentially of a main body, a column of elongated fins, and a handle. The main body may be a rigid and non-hollow polyhedral plate that includes opposing (first and second) body surfaces. The elongated fins may be rigidly secured to the main body and all project substantially orthogonally outward from the front (first) body surface. The elongated fins may be substantially mutually parallel with one another and spaced in face-to-face relationship with one another. Each elongated fin has a fin thickness that is less than a plate thickness of the main body. The handle may be rigidly secured to the main body and project outward from the back (second) body surface. The main body and elongated fins are integrally formed as a single-piece structure from the same metallic material. The handle may be integrally formed with the instrument's body and fins or, alternatively, may be secured to the main body by mating external threads on one end of the handle to internal threads of a complementary tapped hole recessed into a backside of the main body. The hand-held, pluck-type idiophone instrument may be less than 12 in. long and less than six in. high.

For any of the disclosed instruments and methods, the elongated fins may be integrally formed with the main body a single-piece, unitary structure. As another option, each of the elongated fins may project substantially orthogonally from the main body surface. It may be desirable that all of the elongated fins project from the same surface on one side of the main body. The main body surface may have a polyhedral plan-view profile, which may take on a trapezoidal or parallelogrammatic shape. The elongated fins may extend substantially the entire length of the main body surface.

For any of the disclosed instruments and methods, the main body and the elongated fins may be formed, in whole or in part, with a metallic material. In at least some designs, the main body and the elongated fins may be integrally formed, e.g., via casting, extrusion, 3D-printing, etc., as a single-piece structure from the metallic material. Alternatively, the fins and body may be formed via metal injection molding (MIM) or cut as discrete parts that are jointed together via welding. It may be desirable that the metallic material be extruded aluminum 6063. The main body may consist essentially of a rigid, substantially flat plate (i.e., the instrument's main body is neither hollow nor a box). In this instance, the main body may be a polyhedral structure with a trapezoidal profile. It is also envisioned that the idiophone instrument may consist essentially of the elongated fins and the main body surface (e.g., with or without an optional handle).

For any of the disclosed instruments and methods, the idiophone instrument may include a first set of mutually parallel fins arranged in a first column and a second set of mutually parallel fins arranged in a second column adjacent the first column. In this instance, all of the fins in the first set of mutually parallel fins may be longer than all of the fins in the second set of mutually parallel fins. As another option, the first column of fins may be substantially parallel to the second column of fins and separated by an intermediate column-to-column gap. Each of the elongated fins may have a respective length that is distinct from the lengths of all other fins. Moreover, each elongated fin may have a polygonal plan-view profile with two major edges adjoining two mirror edges. In this instance, each of the elongated fins may be rigidly secured to the main body surface along one of the major edges thereof. The fins' polygonal plan-view profile may be trapezoidal such that the two major edges are substantially parallel to each other and the two mirror edges are non-parallel to each other.

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIGS. 1A and 1B are elevated front and rear perspective-view illustrations, respectively, of a representative idiophone-type musical instrument in accordance with aspects of the present disclosure.

FIGS. 1C and 1D are front and rear plan-view illustrations, respectively, of the representative idiophone-type musical instrument of FIGS. 1A and 1B.

FIGS. 2A and 2B are elevated front and rear perspective-view illustrations, respectively, of another representative idiophone-type musical instrument in accordance with aspects of the present disclosure.

FIGS. 2C and 2D are front and rear plan-view illustrations, respectively, of the representative idiophone-type musical instrument of FIGS. 2A and 2B.

The present disclosure is amenable to various modifications and alternative forms, and some non-limiting, representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Brief Description of the Drawings, and Detailed Description sections, but not explicitly set forth in the claims, should not be incorporated into the claims, singly or collectively, by implication, inference or otherwise. Moreover, recitation of “first”, “second”, “third”, etc., in the specification or claims is not per se used to establish a serial or numerical limitation; unless specifically stated otherwise, these designations may be used for case of reference to similar features in the specification and drawings and to demarcate between similar elements in the claims.

For purposes of this disclosure, unless specifically disclaimed: the singular includes the plural and vice versa (e.g., indefinite articles “a” and “an” should generally be construed as meaning “one or more”); the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at, near, or nearly at” or “the same or practically the same as” or “within 0-5% of” or “within acceptable manufacturing tolerances,” or any logical combination thereof, for example.

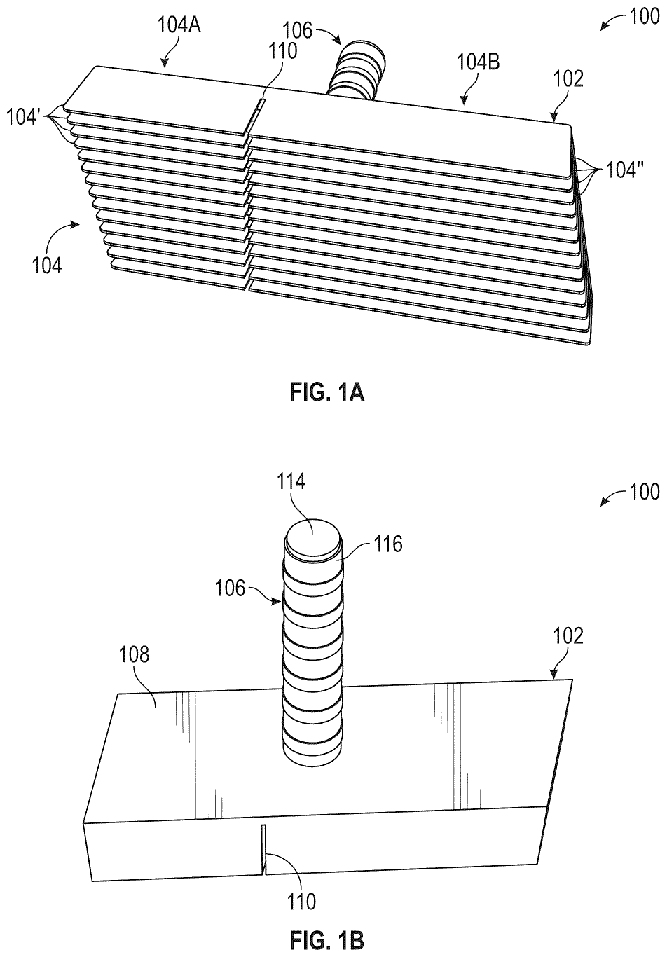

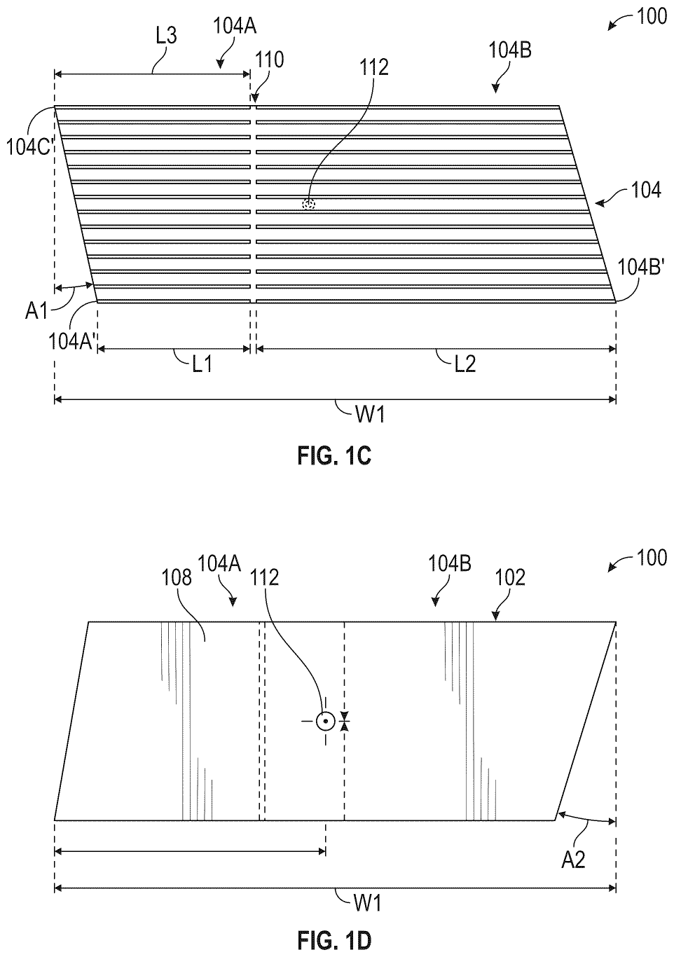

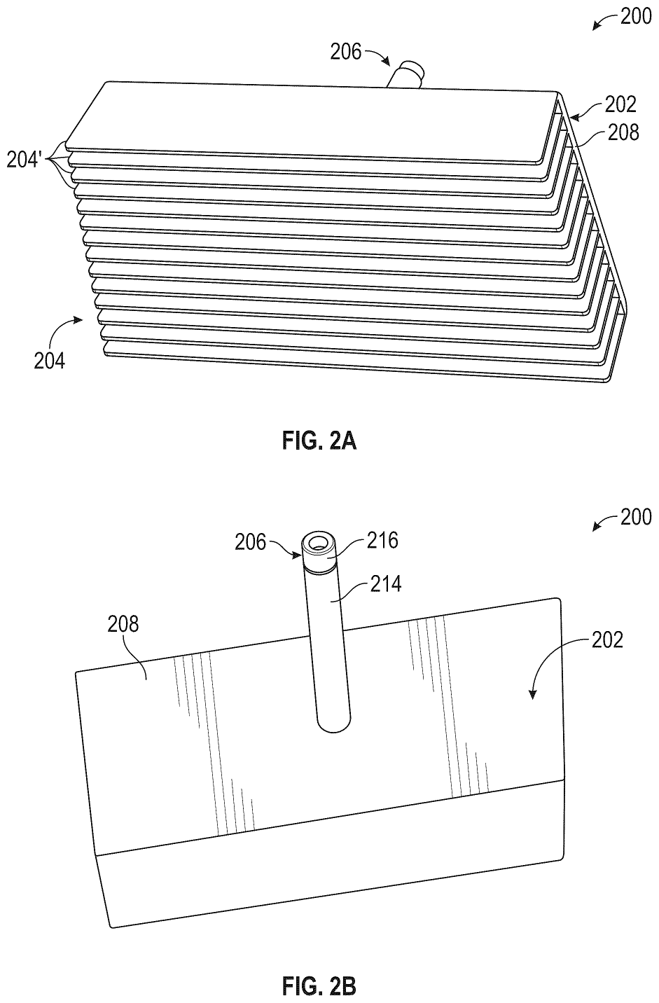

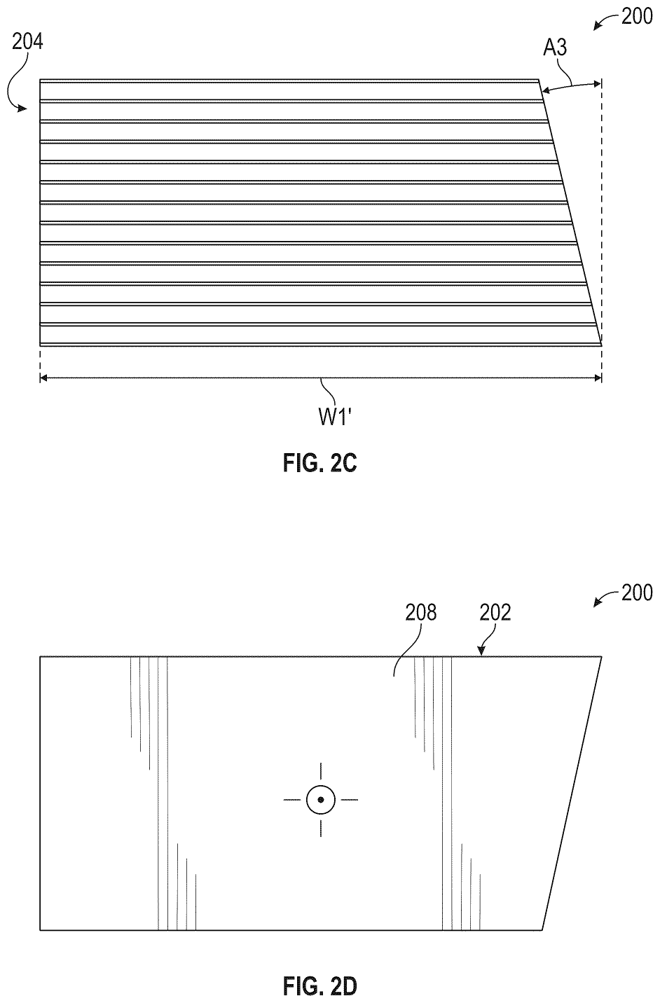

Referring now to the drawings, wherein like reference numbers refer to like features throughout the several views, there is shown in FIGS. 1A-1D a first example of an idiophone-type musical instrument, which is designated generally at 100 and portrayed herein for purposes of discussion as a handheld and portable lamellophone. The idiophone-type musical instrument 100 (also referred to herein as “idiophone instrument” or “instrument” for short) includes a main body 102, a series of elongated fins 104, and an optional handle 106. In the same vein, a second example of an idiophone instrument, which is a handheld and portable lamellophone designated generally at 200 in FIGS. 2A-2D, also includes a main body 202, a series of elongated fins 204, and an optional handle 206. Although differing in appearance, it is envisioned that any of the options and features described herein with reference to the instrument 100 of FIGS. 1A-ID may be incorporated, singly or collectively, into the instrument 200 of FIGS. 2A-2D, and vice versa. By way of non-limiting example, it is envisioned that the handles 106 and 206 may be altogether omitted from the instruments 100, 200, e.g., for a “countertop” design or, if desired, may be replaced with a shoulder strap or stand.

With collective reference to FIGS. 1A, ID, 2A, and 2D, the main body 102, 202 of the idiophone instrument 100, 200 may include a rigid and elongated body wall 108 and 208. In contrast to many existing lamellophone designs, in which the instrument's main body is a hollow box or shell-known as a “soundboard”—the main body 102, 208 of the two illustrated idiophones 100, 200 may consist essentially of the rigid body wall 108, 208 sans internal cavities and sound holes. To that end, the instrument 100, 200 may lack a mounting (Z) bracket, fasteners, adhesives, frame, bar cord, etc., for fixing the fins to the body. As shown, the rigid body wall 108, 208 is a substantially flat, polyhedral plate of uniform thickness. The shape of the instrument body 102, 202 may be selected to provide a desired sound while also being substantially coterminous with the outer periphery of the series of fins 104, 204. It should be appreciated that the instruments' main body 102, 202 may take on an assortment of different shapes and sizes without departing from the intended scope of this disclosure. In the illustrated examples, the shape of the instrument body 102, 202 was selected to provide a desired sound while also being substantially coterminous with the outer periphery of the series of fins 104, 204.

Both of the illustrated main body walls 108, 208 may have a polygonal plan-view profile: the main body wall 108 of FIGS. 1A-1D has a parallelogrammatic profile whereas the main body wall 208 of FIGS. 2A-2D has a trapezoidal profile. As best seen in FIGS. 1C and 1D, the two (left and right) mirror edges of the main body wall 108 at the longitudinal ends of the main body 102 may have an oblique pitch angle A1 and A2, e.g., of about fifteen (15) degrees, with respect to the two (top and bottom) major edges of the main body wall 108 on the lateral sides of the body 102. In contrast, only one (right) mirror edge of the main body wall 208 at one (right) longitudinal end of the main body 202 may have an oblique pitch angle A3, e.g., of about fifteen (15) degrees, with respect to the two major edges on the lateral sides of the main body 202, as best seen in FIGS. 2C and 2D. The other (left) mirror edge at the other (left) longitudinal end of the main body 202 may be perpendicular to the two major edges of the main body 202. It is envisioned that the main body wall 108, 208 may take on other regular and irregular profile shapes.

A series of elastic and elongated “vibrating” fins 104, 204 is rigidly secured to the main body 102, 202 of the instrument 100, 200. The idiophone instrument 100 of FIGS. 1A-ID, for example, has twenty-eight (28) individual fins 104′ and 104″ whereas the idiophone instrument 200 of FIG. 2A has fourteen (14) individual fins 204′. It should be appreciated that the instruments 100, 200 may include greater or fewer fins than that which are shown in the drawings. It is envisioned that the fins 104, 204 and the main body 102, 202 may be fabricated separately from one another, e.g., via stamping or laser cutting, and thereafter joined together, e.g., via welding, dovetail joint, etc. For simplicity of design and manufacture, it may be desired that the main body 102, 202 and elongated fins 104, 204 be integrally formed as a single-piece, unitary structure, e.g., via casting, extrusion, injection molding, 3D-printing, etc. To that end, the main body 102, 202 and the elongated fins 104, 204 may be formed from a variety of different materials, including plastic, fiber-reinforced plastic (FRP), wood, etc. However, it may be desirable that the entire instrument 100, 200 be fabricated from a metallic material, e.g., to provide a desired acoustic sound while ensuring durability and resistance to wear from use. For instance, the main body 102, 202 and elongated fins 104, 204 may be integrally formed as one piece from the same metallic material, such as extruded 6063 aluminum alloy (AA).

To enable strumming and fingerpicking of the idiophone instrument 100, 200, the elongated fins 104, 204 may project outward from the main body wall 108, 208, e.g., with all fins 104, 204 extending in the same direction (out of the page in FIGS. 1C and 2C). In accord with the illustrated examples, all of the fins 104, 204 are substantially flat and project substantially orthogonally from the same surface of the main body wall 108, 208, on a side thereof opposite that of the handle 106, 206. As best seen in FIGS. 1C and 2C, the elongated fins 104, 204 may be substantially parallel to one another and, at the same time, may be vertically spaced from one another while arranged in a face-to-face relationship. Put another way, the elongated fins may be non-coplanar and may be arranged in a columnar “ladder-like” pattern. Comparatively, the vibrating tangs and bars of traditional lamellophones and xylophones are coplanar with one another and arranged side-by-side.

To ensure that each of the individual fins 104′, 104″, 204′ generates a different tone when plucked or struck, each fin 104′, 104″, 204′ may have a respective length that is distinct from the lengths of all the other elongated fins 104, 204. FIG. 1C, for example, illustrates a first vibrating fin 104A′ having a respective first fin length L1, a second vibrating fin 104B′ having a respective second fin length L2 that is greater than the first fin length L1, and a third vibrating fin 104C′ having a respective third fin length L3 that is greater than the first fin length L1 and less than the second fin length L2. On the other hand, all of the fins 104′, 104″, 204′ in a given series of fins 104, 204 may have approximately the same vertical thickness and approximately the same transverse width.

In order to generate a desired sound, each of the elongated fins 104′, 104″, 204′ may have a polygonal plan-view profile with two long “major” edges adjoining two short “mirror” edges. In contrast to many existing lamellophone designs, in which each of the instrument's vibrating tangs are cantilevered at one longitudinal end thereof to the soundboard, and existing xylophone designs, in which each bar is mounted via a bar cord at opposing longitudinal ends thereof to the xylophone frame, each of the elongated fins 104′, 104″, 204′ is rigidly secured to the main body 102, 202 along an innermost major edge thereof. It may be desirable that each fin's 104″ polygonal plan-view profile be trapezoidal such that the two major edges are substantially parallel to each other and the two mirror edges are non-parallel to each other, as seen in FIG. 1A. It may also be desirable that some or all of the fins 104′, 204′ take on a rectangular plan-view profile such that the two major edges are substantially parallel to each other and the two mirror edges are substantially parallel to each other. The instruments' vibrating fins 104′, 204′ may take on other regular and irregular profile shapes.

Disclosed idiophone instruments 100, 200 may have a single set of elongated fins 204, as shown in FIGS. 2A-2D, or multiple sets of elongated fins 104, as shown in FIGS. 1A-1D. By way of example, and not limitation, the idiophone instrument 100 of FIGS. 1A-1D has a first (left) set or column 104A of mutually parallel fins 104′ that is arranged in a first (left) column, and a second (right) set or column 104B of mutually parallel fins 104″ that is arranged in a second (right) column, which is spaced from and adjacent the first column. As best seen in FIG. 1C, the first column 104A of mutually parallel fins 104′ may be substantially parallel to the second column 104B of mutually parallel fins 104″, with the two columns separated by a central gap 110. Alternative instrument designs may include more than two columns of fins, with each column containing greater or fewer than fourteen (14) individual fins.

To provide a variety of different tones, all of the elongated fins 104′ in the first set of mutually parallel fins 104A may be longer than all of the fins 104″ in the second set of mutually parallel fins 104B. Moreover, the fins 104′ in the first set 104A may have respective lengths that are distinct from one another, and the fins 104″ in the second set 104B may have respective lengths that are distinct from one another. In the configuration of FIGS. 1A-1D, each fin 104′ in the first set of fins 104A extends less than half of a total body width W1 of the main body 102, whereas each fin 104″ in the second set of fins 104B extends more than half the width W1 of the main body 102. Comparatively, a longest “major” fin length of each fin 204 in FIGS. 2A-2D is substantially equal to a corresponding width W1′ of the main body wall 208.

Each of the illustrated handles 106, 206 is portrayed as a rigid, right-circular cylinder 114, 214 that is rigidly secured to the instrument's main body 102, 202 and projects outward from a rear (second) surface of the main body 102, 202 opposite the front (first) surface from which the fins 104, 204 project. The handle 106, 206 may be integrally formed with the instrument's body 102, 202 and fins 104, 204 as a single-piece structure from the same metallic material. Alternatively, each handle 106, 206 may be fabricated as a discrete component that is secured to the main body 102, 202 by mating external threads on one end of the handle 106, 206 to internal threads of a complementary tapped hole 112 recessed into the rear surface of the main body 102, 202. In this latter example, the handles 106, 206 may be formed from polymeric or polymer-composite materials or may be formed from a metallic material (as shown) and sheathed in an optional compressive grip 116 or tipped at one end thereof with a handle cap 216.

Aspects of the present disclosure have been described in detail with reference to the illustrated embodiments; those skilled in the art will recognize, however, that many modifications may be made thereto without departing from the scope of the present disclosure. The present disclosure is therefore not limited to the precise construction and compositions disclosed herein; any and all modifications, changes, and variations apparent from the foregoing descriptions are within the scope of the disclosure as encompassed by the appended claims. Moreover, the present concepts expressly include any and all combinations and subcombinations of the preceding elements and features.

What is claimed:

1. An idiophone instrument, comprising:
a main body including a main body surface; and
a plurality of elongated fins rigidly secured to the main body and projecting outward from the main body surface, the elongated fins being substantially mutually parallel with one another and spaced in face-to-face relationship with one another.

2. The idiophone instrument of claim 1, wherein the elongated fins are integrally formed with the main body as a single-piece structure.

3. The idiophone instrument of claim 1, wherein each of the elongated fins is substantially flat and projects substantially orthogonally from the main body surface.

4. The idiophone instrument of claim 1, wherein all of the elongated fins project from the main body surface on one side of the main body.

5. The idiophone instrument of claim 1, wherein the main body and the elongated fins are formed with a metallic material.

6. The idiophone instrument of claim 5, wherein the main body and the elongated fins are integrally formed as a single-piece structure from the metallic material.

7. The idiophone instrument of claim 6, wherein the metallic material is extruded aluminum 6063.

8. The idiophone instrument of claim 1, wherein the main body consists essentially of a substantially flat and rigid plate.

9. The idiophone instrument of claim 8, wherein the rigid plate is a polyhedral structure with a trapezoidal or parallelogrammatic profile.

10. The idiophone instrument of claim 1, wherein the plurality of elongated fins includes a first set of mutually parallel fins arranged in a first column and a second set of mutually parallel fins arranged in a second column adjacent the first column.

11. The idiophone instrument of claim 10, wherein all fins in the first set of mutually parallel fins are longer than all fins in the second set of mutually parallel fins.

12. The idiophone instrument of claim 10, wherein the first column is substantially parallel to the second column.

13. The idiophone instrument of claim 1, wherein each fin of the elongated fins has a respective length distinct from the lengths of all other fins of the elongated fins.

14. The idiophone instrument of claim 1, wherein each of the elongated fins has a polyhedral plan-view profile with two major edges adjoining two mirror edges, and wherein each of the elongated fins is rigidly secured to the main body along one of the major edges thereof.

15. The idiophone instrument of claim 14, wherein the polyhedral plan-view profile is trapezoidal, the two major edges are substantially parallel to each other, and the two mirror edges are non-parallel to each other.

16. The idiophone instrument of claim 1, characterized by a lack of a mounting bracket and fasteners securing the elongated fins to the main body.

17. The idiophone instrument of claim 1, further comprising a handle rigidly secured to the main body and projecting outward from another main body surface on a side of the main body opposite the elongated fins.

18. The idiophone instrument of claim 1, wherein a longest fin length of the elongated fins is substantially equal to a longest body width of the main body.

19. A method of manufacturing an idiophone instrument, the method comprising:
forming a main body including a main body surface; and
rigidly securing a plurality of elongated fins to the main body such that the elongated fins project outward from the main body surface, the elongated fins being substantially mutually parallel with one another and spaced in face-to-face relationship with one another.

20. A hand-held, pluck-type idiophone instrument, consisting essentially of:
a main body including a first body surface opposite a second body surface, the main body being a rigid, substantially flat, and non-hollow polyhedral plate with a plate thickness;
a column of substantially flat and elongated fins rigidly secured to the main body and all projecting substantially orthogonally outward from the first body surface, the elongated fins being substantially mutually parallel with one another and spaced in face-to-face relationship with one another, the elongated fins having a fin thickness less than the plate thickness of the main body; and
a handle rigidly secured to the main body and projecting outward from the second body surface,
wherein the main body and the elongated fins are integrally formed as a single-piece structure from a metallic material.
